(19) United States
(12) Patent Application Publication
(10) Pub. No.: US 2002/0116314 A1
(43) Pub. Date: Aug. 22, 2002

(54) Method of using a computerised trading system to process trades in financial instruments

(76) Inventors: Michael Spencer, London (GB); Kieron Nolan, London (GB)

Correspondence Address: LUEDEKA, NEELY & GRAHAM, P.C., P O BOX 1871, KNOXVILLE, TN, 37901, US

(21) Appl. No.: 09/777,987

(22) Filed: Feb. 6, 2001

(30) Foreign Application Priority Data
Dec. 19, 2000 (GB) 0030964.1

(51) Int. Cl. G06F 17/60

(52) U.S. Cl. 705/37

(57) ABSTRACT

The present invention relates to a method of use of a computerised trading system to process trades in financial instruments. The computerised trading system comprises a trading system computer apparatus (10); a plurality of client computer apparatus (11, 12, 13, 14, 15, 16) located physically remote from each other and physically remote from the trading system computer apparatus (10); and a telecommunications network interlinking the trading system computer apparatus (10) and the plurality of client computer apparatus (11, 12, 13, 14, 15, 16). The method comprises the steps of:

(a) a first plurality of traders using the client computer apparatus (11, 12, 13, 14, 15, 16) to send to the trading system computer apparatus (10) via the telecommunications network a plurality of offers for sale of financial instruments;

(b) a second plurality of traders using the client computer apparatus (11, 12, 13, 14, 15, 16) to send to the trading system computer apparatus (10) via the telecommunications network a plurality of bids for purchase of financial instruments; and

(c) a trading administrator using the trading system computer apparatus (10) to:

establish a succession of time limited order entry periods during which offers for sale and bids for purchase can be submitted to the trading system computer apparatus: (10);

compare all offers for sale and bids for purchase made in a single order entry period at the end of the order entry period;

to match where possible the compared offers for sale and bids for purchase;

to record for each order entry period at least one benchmark trading rate; and

to make available electronically via the telecommunications network to all relevant traders information regarding the offers and/or bids which have been matched, such information for each matched pair of offer and bid being sent only to the traders who made the matched offer and bid and such information including the identity of the traders responsible for each matched pair of offer and bid and the benchmark trading rate set for the transaction.

### FIELD OF THE INVENTION

The present invention relates to a method of using a computerised trading system to process trades in financial instruments.

### BACKGROUND OF THE INVENTION

The present invention will be described in particular with reference to a method of using a computerised trading system for trading interest rate SWAPS. SWAPS are a financial product whereby one party pays a fixed interest against a counterparty that pays a floating interest rate.

Traditionally, SWAPS have been traded through the intervention of a human broker. The broker will receive buying orders and selling orders and will match buyers to sellers at a price agreed between the buyer and the seller.

Recently, there has been a trend to trade of financial instruments over the Internet. This poses particular difficulties for the trading of SWAPS. The present invention seeks to resolve those difficulties.

### SUMMARY OF THE INVENTION

According to the present invention there is provided a method of use of a computerised trading system to process trades in financial instruments, the computerised trading system comprising:

a trading system computer apparatus;

a plurality of client computer apparatus located physically remote from each other and physically remote from the trading system computer apparatus; and

a telecommunications network interlinking the trading system computer apparatus and the plurality of client computer apparatus;

wherein:

the method comprises the steps of:

(a) a first plurality of traders using the client computer apparatus to send to the trading system computer apparatus via the telecommunications network a plurality of offers for sale of financial instruments;

(b) a second plurality of traders using the client computer apparatus to send to the trading system computer apparatus via the telecommunications network a plurality of bids for purchase of financial instruments; and

(c) a trading administrator using the trading system computer apparatus to:

establish a succession of time limited order entry periods during which offers for sale and bids for purchase can be submitted to the trading system computer apparatus;

to compare all offers for sale and bids for purchase made in a single order entry period at the end of the order entry period;

to match where possible the compared offers for sale and bids for purchase;

to record for each trading period at least one benchmark trading rate ;and

to make available electronically via the telecommunications network to all relevant traders information regarding the offers and/or bids which have been matched, such information for each matched pair of offer and bid being sent only to the traders who made the matched offer and bid and such information including the identity of the traders responsible for each matched pair of offer and bid and the benchmark trading rate set for the transaction.

### BRIEF DESCRIPTION OF THE DRAWINGS

A first embodiment of the present invention will now be described with reference to the accompanying drawings in which:

FIG. 1 is a schematic diagram illustrating a preferred embodiment of computerised trading system according to the present invention.

FIG. 2 is a flow diagram showing the steps implemented by the trading system of FIG. 1;

FIG. 3 is a view of a first page shown on a screen of a computer in the trading system of FIG. 1;

FIG. 4 is a view of a second page shown on a screen of a computer in the trading system of FIG. 1;

FIG. 5 is a view of a third page shown on a screen of a computer in the trading system of FIG. 1;

FIG. 6 is a view of a fourth page shown on a screen of a computer in the trading system of FIG. 1;

FIG. 7 is a view of a fifth page shown on a screen of a computer in the trading system of FIG. 1;

FIG. 8 is a view of a sixth page shown on a screen of a computer in the trading system of FIG. 1;

FIG. 9 is a view of a seventh page shown on a screen of a computer in the trading system of FIG. 1; and

FIG. 10 is a view of an eighth page shown on a screen of a computer in the trading system of FIG. 1.

### DETAILED DESCRIPTION OF THE PREFERRED EMBODIMENT(S)

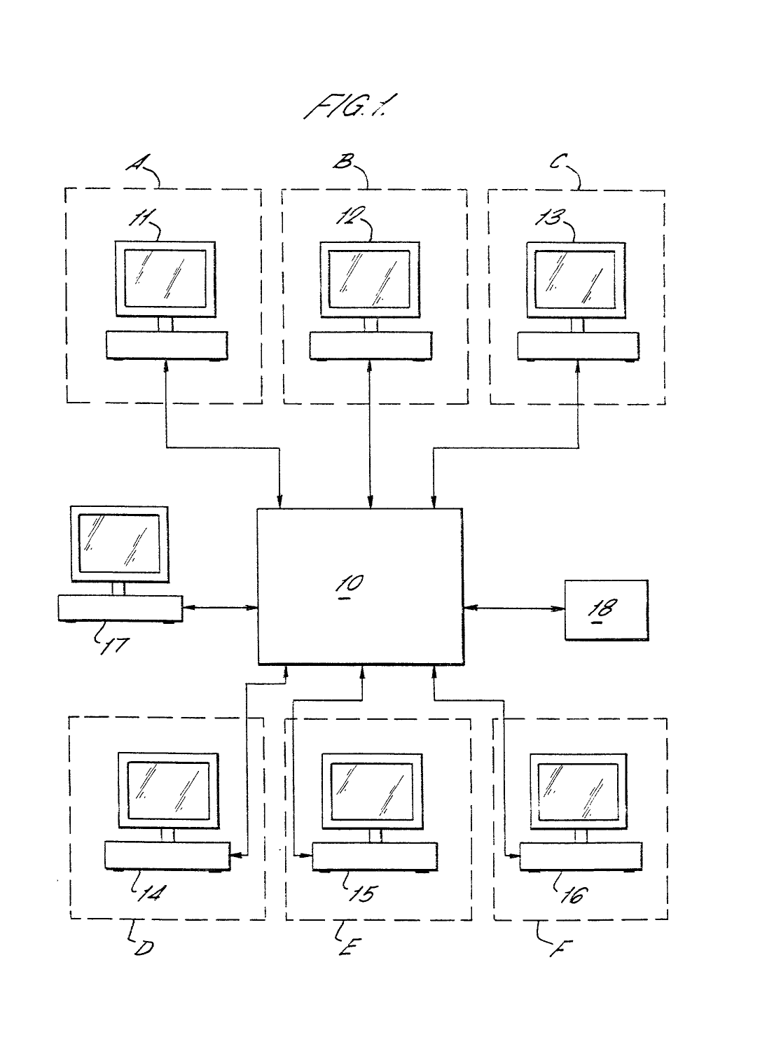

In FIG. 1 there can be seen a distributed computer network. The computer network comprises a trading system computer apparatus 10 which is connected by a telecommunications network (e.g. the Internet) to a plurality of physically remote client computer apparatus 11, 12, 13, 14, 15 and 16. Data will be exchanged via the telecommunications network between the server 10 and the client computer apparatus 11-16. Also shown in FIG. 1 is a terminal (e.g. a personal computer) 17 connected to the computerised trading system computer apparatus 10, with the terminal 17 being used by a system administrator of the system. The server 10 is also connected via the telecommunications network to information server 18, to receive financial information from the server 18. This will be described later.

The client computer apparatus 11-16 will typically comprise personal computers located at a plurality of different bank sites A, B, C, D, E, F. For convenience, only six sites are shown in FIG. 1 but it will be appreciated that any number of sites could be provided. Each personal computer 11-16 will have web browser software, for instance Microsoft Internet Explorer Version 5.0 (or higher) or Netscape Navigator Version 4.7 (or higher).

The web browser software on the client computer apparatus 11-16 will be used to access a URL and via the URL exchange information with the computerised trading system computer apparatus 10. In a preferred embodiment the telecommunication network used will be the Internet, with the URL being a website on the Internet and the client computer apparatus 11-16 using the web browser software to access the website on the Internet.

The system administrator will use the personal computer 17 to access a different URL which will allow access to maintenance functionality of the trading system computer apparatus 10.

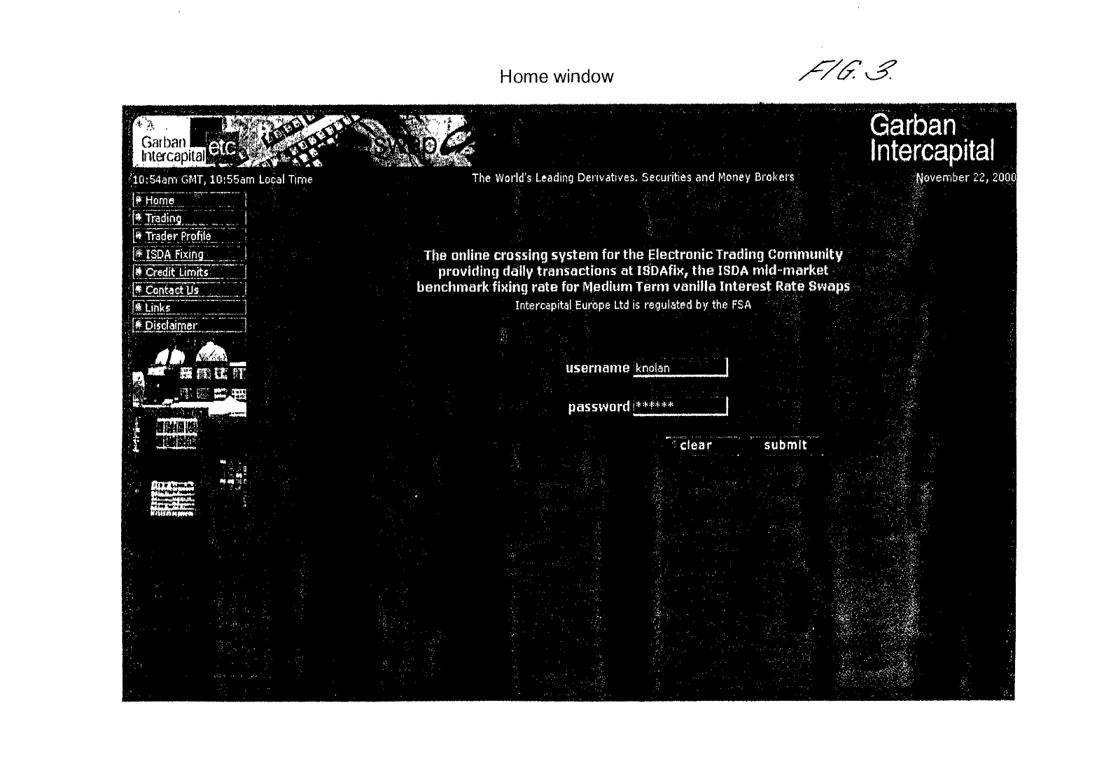

A method of operation of the system will now be described. A trader at a financial institution A (e.g. a bank) will use a personal computer 11 and web browser software on the personal computer 11 to access the trading site URL, which in turn is connected to the system server 10. Initially, the trader will be presented with a window as shown in FIG. 3 and will be required to enter his/her user name and password. The combination of user name and password will be verified before access to the computerised trading system can be obtained. User names and passwords will be supplied to traders by the system administrator, who will also handle the allocation and maintenance of the user names and passwords. It is envisaged that this will be done outside the computerised system, with no provision for on-line registration. Each trader will be asked to change his/her password when he/she first logs on to the trading site URL.

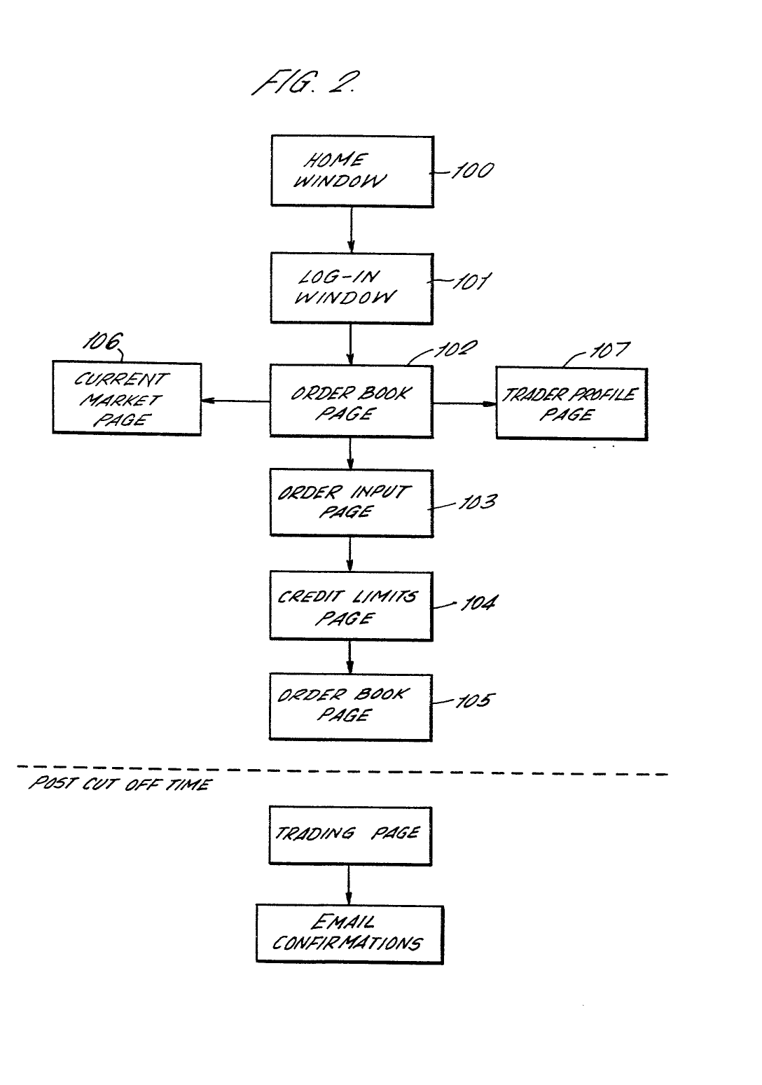

FIG. 2 shows an initial access by a trader to a home page at step 100 and then input of the user name and password at step 101.

Correct entry of a user name and password will take the trader to a trading window. This is illustrated in the figures which will be described below.

Incorrect entry of a user name will cause a display message to appear informing the trader that the user name has been entered incorrectly. Incorrect entry of a password, when the user name has been entered correctly, will result in a display message informing the trader that he/she has entered an incorrect password and there will be a limited number of attempts left for the entry of a correct password. A number of attempts will be definable by the system administrator via the maintenance page available on a different URL to a system administrator. When the total number of permissible attempts has been reached then a trader will be informed that he/she has been locked out of the system and he/she will need to contact the system administrator before access will be granted again, even if the correct user name and password are entered.

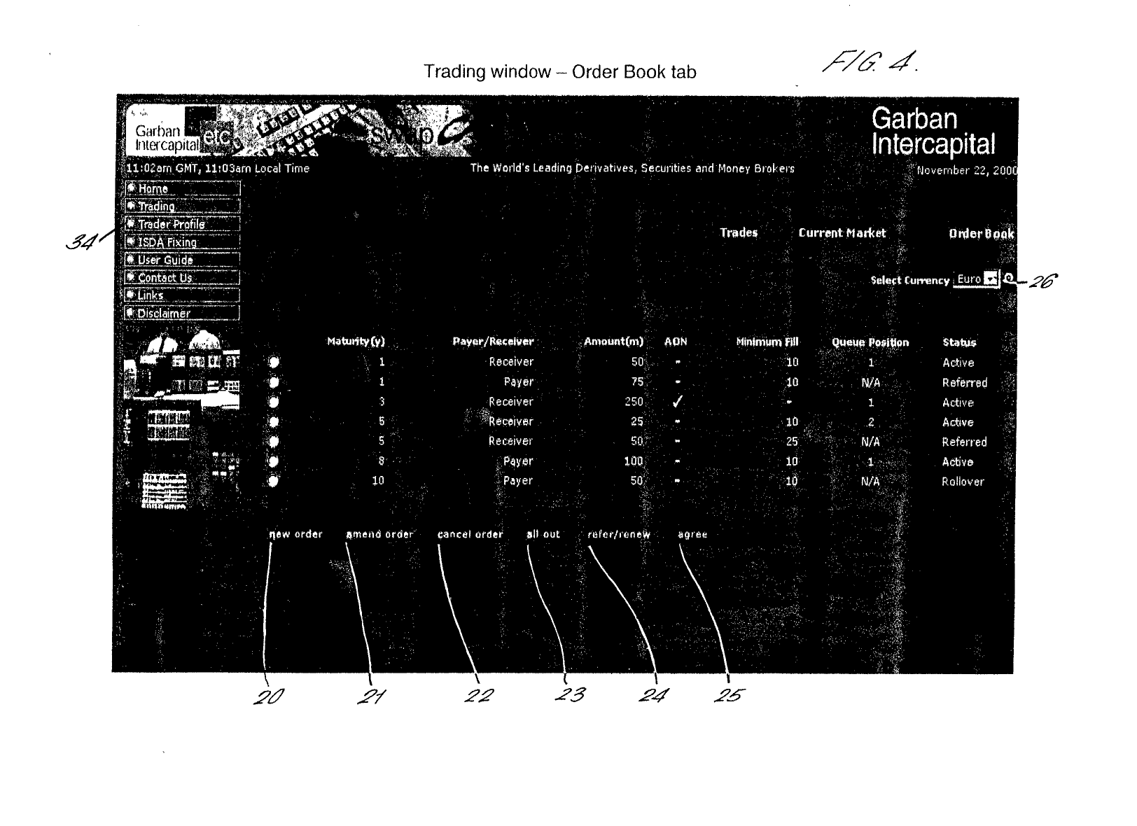

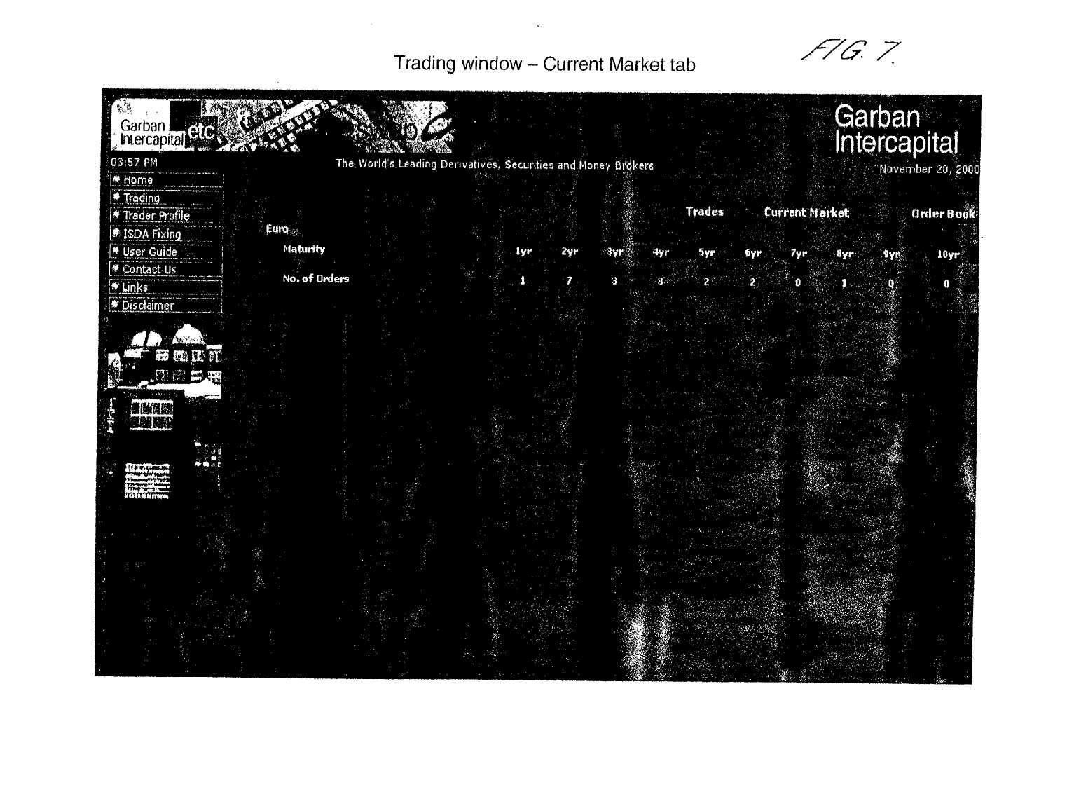

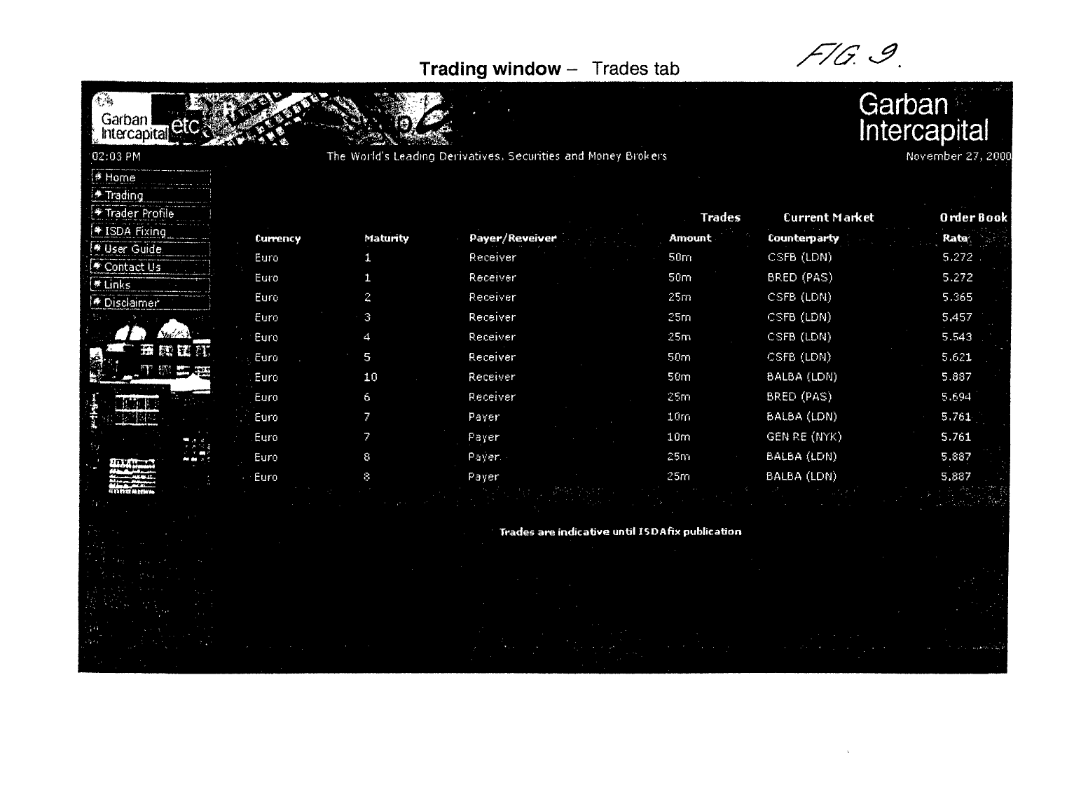

The correct entry of a user name and password combination will allow the trader to access a trading window, this being shown by step 102 in FIG. 2. An example of a trading window is given in FIG. 4. The trading window has three tabbed pages, an “Order Book” page (FIG. 4), a “Current Market” page (FIG. 7) and a “Trades” page (FIG. 9). On initial entry to the system the trader is presented with the “Order Book” page shown in FIG. 4. The page will have a number of “buttons” which can be “clicked” on. The page will also be linked to a “Trader Profile” page and a “Benchmark” page (discussed later). The following buttons are visible on the page: “New Order” button 20, “Cancel Order” button 22, “All Out” button 23, “Refer/Renew” button 24 and “Agree” button 25.

The “Agree” button 25 may only be available at certain times in the operation of a system, which will be described later.

The “Order Book” page of the trading window allows each trader to view and amend his/her orders. A currency selection can be made by a drop-down box 26. In the illustrated embodiment, trading in Euros is shown. It is envisaged that the computerised trading system will allow trading in a plurality of different currencies, e.g. Euro, Sterling, US Dollars, Japanese Yen, Swiss Francs.

The trader will be able using the “Order Book” page to click on a particular order to highlight the order. Only one order can be highlighted at any one time.

For each order the following information will be shown:

| | |
|---|---|
| Maturity | e.g. between one year, two years, three |
| | years, four years etc |
| Payer/Receiver | to indicate whether the client is a |
| | payer (i.e. the trader has entered a |
| | bid for the purchase of SWAPS) or a |
| | receiver (i.e. the trader has entered |
| | an offer for sale of SWAPS) |
| Amount | the amount of the bid or offer |
| AON | this will be highlighted to indicate if |
| | the trader has indicated that the |
| | trader will only deal for the total |
| | amount and will not split the offer or |
| | bid into smaller amounts |
| Minimum Fill | this shows the minimum fill amount |
| | specified by a trader, the minimum fill |
| | amount being the minimum value offer or |
| | bid that the trader will consider as |
| | part of a package of offers or bids to |
| | complete the whole order |
| Queue Number | the position of the order in the order |
| | queue (allocated by the computerised |
| | trading system) |
| Status | this indicates whether the order is |
| | active, referred or rollover. |

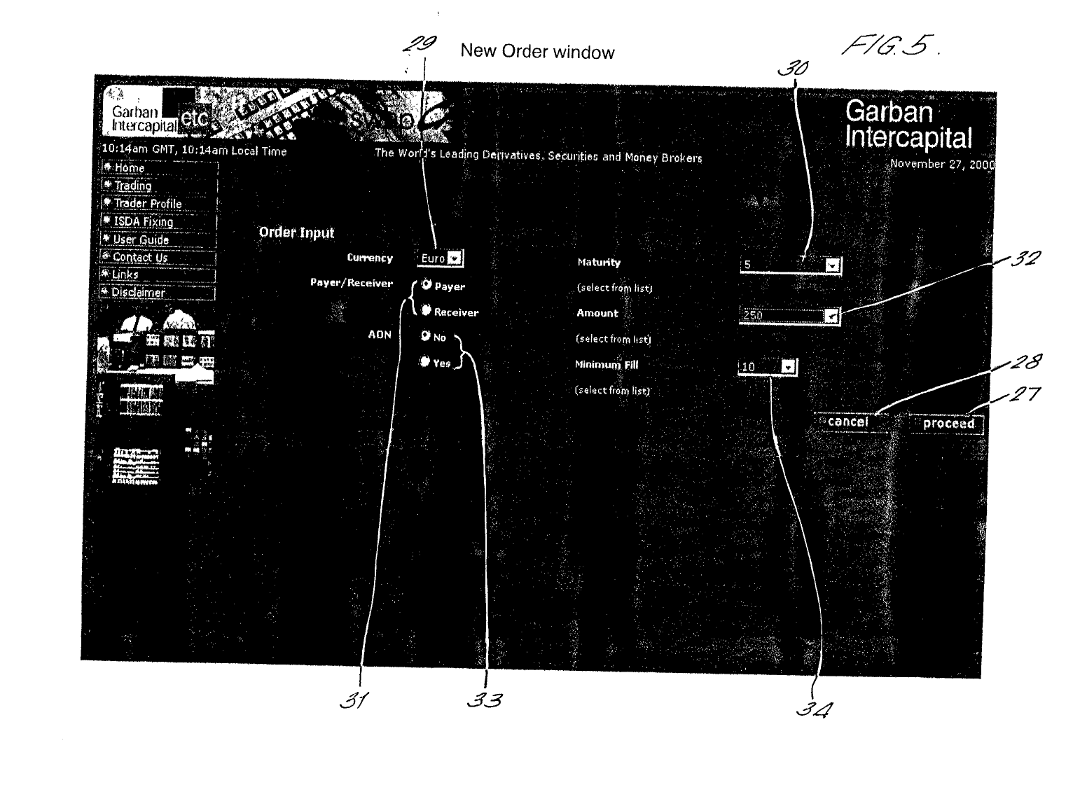

The trader can click on the New Order button 20 to be presented with an “Order Input Box” as shown in FIG. 5. The Order Input Box has a “Proceed” button 27, a “Cancel” button 28 and six data entry fields. The fields are as follows:

| | |
|---|---|
| Currency | the trader will select at field 29 between |
| | the various available currencies, trading in |
| | Euros being shown in the Figure. |
| Maturity | the trader will select at field 30 between |
| | the available maturities, e.g. one year, two |
| | years, three years etc (5 years is shown) |
| Payer/ | |
| Receiver | the trader will select whether they are |
| | a payer or a receiver (″payer″ selection is |
| | shown) |
| Amount | the trader will enter an amount at field 32. |
| | The amount has to be above a minimum size |
| | and has to be in predetermined values, |
| | depending upon the currency selected. It is |
| | assumed that for Sterling the minimum size |
| | will be £5,000,000 and the predetermined |
| | values will be e.g. £10, £25, £50, £75, |
| | 100, £250 or £500 million (larger values |
| | available in multiples of 100 million). The |
| | system administrator will be able to amend |
| | the minimum size and predetermined value for |
| | each currency via the Maintenance page |
| AON | at field 33 the trader will be able to |
| | select YES or NO relating to whether or not |
| | they would like to specify the order as “ALL |
| | OR NOTHING” (AON) . A deal that is AON will |
| | be matched only when the full amount can be |
| | met by other orders. When the trader selects |
| | NO then an amount less than the fill order |
| | amount can be filled. |
| Minimum | |
| Fill | the trader will be optionally able to select |
| | a minimum fill amount at field 34. The |
| | minimum fill amount is the minimum a trader |
| | is prepared to trade with any one financial |
| | institution (e.g. banks) in a single order. |
| | This amount must be above the currency's |
| | minimum amount or must be one of the |
| | currency's predetermined values and must be |
| | below the amount specified in the amount |
| | field. |

It is envisaged that the system administrator could program into the computerised trading system 10 for each trader at the request of the trader default amounts in each of the six boxes equal to those in the immediately previous trade. This will ease completion of the New Order Page.

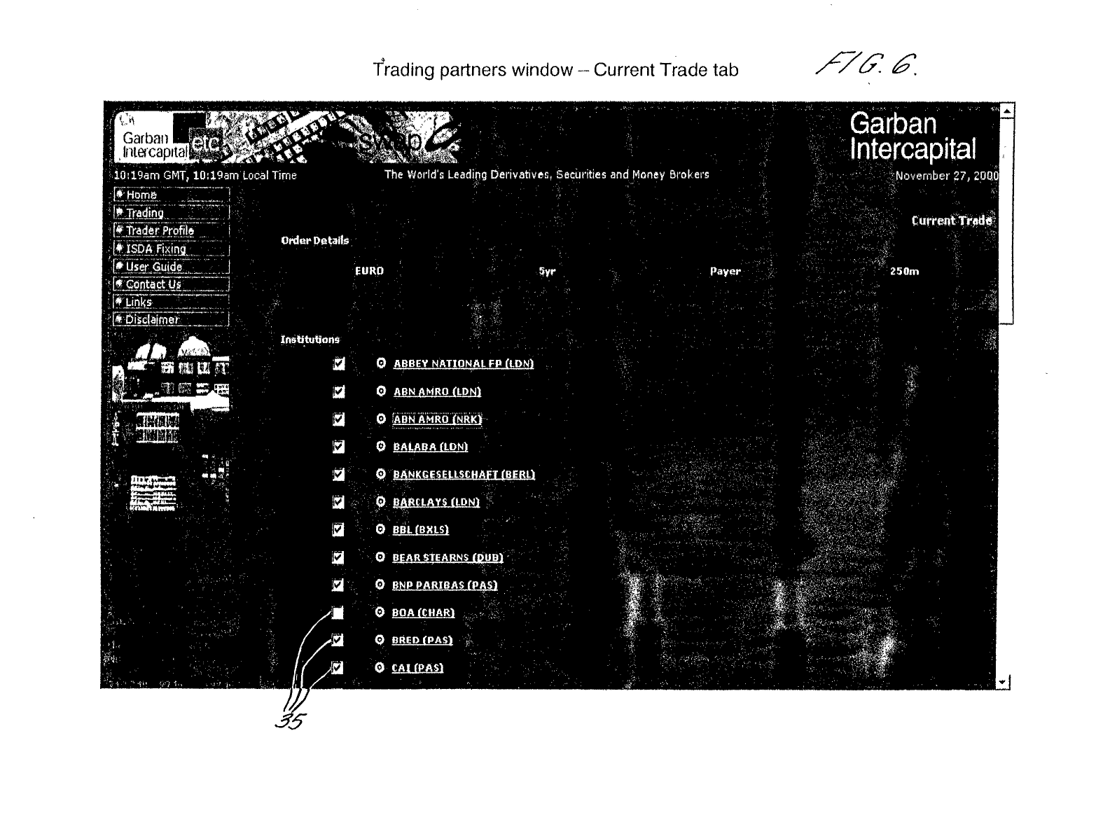

Once a trader clicks the “Proceed” button 27 then the New Order Page is closed and a “Credit Limit” page is automatically opened. The Credit Limit page is shown in FIG. 6 and will now be described.

Financial institutions normally set credit limits for the other financial institutions with whom they trade. These financial limits limit the maximum amount of exposure a trader can have with each possible counterpart. This is to limit the maximum amount of risk one financial institution can have with another, in case one financial institution defaults.

The “Credit Limit” page will allow each trader to select with which other financial institutions they will trade for each bid or offer. The “Credit Limit” page shows at the top details of the relevant order these being the currency, the amount, the maturity period and whether the trader is acting as payer or receiver. The page will also list the names of all financial institutions who have signed up to use the computerised trading system. A Tick box 35 is displayed next to the name of each financial institution. When a trader ticks a box next to a name of a financial institution, this will indicate that the trader is agreeing that his financial institution will trade with the specified financial institution for the current order up to the total amount of the order in the relevant maturity period. If a trader has already approved a longer maturity for the counterparty then the page will default to a tick which is colour coded to show that it is an automatic default. If a trader has previously approved limits for shorter maturities there will be a question mark indicated. If this is not amended by the trader then this will indicate that a limit does not exist for the particular maturity in question.

To complete a new order the “Credit Limit” page is closed by clicking a Proceed button. The new order is automatically reflected in the “Order Book” page (FIG. 4) and in a “Current Market” page (FIG. 7). The completion of the “Credit Limit” page is shown as step 104 in FIG. 2. At this time the computerised trading system gives the new order a queue number indicating the priority of the order in the list of orders received by the computerised trading system. The queue numbers are issued sequentially for each maturity, so that the first order in a trading period for a financial instrument with a particular maturity is given the highest priority. The trader is returned to the “Order Book” page (FIG. 4) after completion of the “Credit Limit” page. This is shown as step 105 in FIG. 2.

The “Amend Order” button 21 present on the Trading page (see FIG. 4) can be used to amend existing orders. When the “Amend Order” button is clicked then an “Order Input” page (FIG. 5) will be shown populated with details of an order which has been previously highlighted in the “Order Book” page (FIG. 4). If the button 21 is clicked when no order is highlighted, a message box will appear asking the trader to select an order. Once an order has been selected then the “Order Input” page (FIG. 5) for that order will appear with the prerecorded details. The trader will then be able to change any of the fields within the “Order Input” page (FIG. 5).

The “Order Book” page (FIG. 4) also has a “Cancel Order” button 22. When the “Cancel Order” button 22 is clicked then (following confirmation from the trader) the order highlighted on the “Order Book” page is removed from the computerised trading system. This will cause the computerised trading system 10 to automatically update the numbers of orders and this will be shown in the “Order Book” page (FIG. 4) and the “Current Market” page (FIG. 7).

If the “Cancel Order” button 22 is selected when there is no order highlighted previously, then a message box will appear to ask the trader to select an order. Once an order has been selected then the same process will take place.

There is also provided on the trading page the “All Out” button 23. When this button is clicked then (following confirmation from a trader) all of the orders for the trader for all maturities and all currencies will be removed from the computerised trading system. This will be automatically reflected in the “Order Book” page (FIG. 4) and the “Current Market” page (FIG. 7). The queue numbers of any other orders for the same maturity and currency will automatically be updated on the displays accessed by all traders.

Further available on the trading page is the “Refer/Renew” button 24. When this button is clicked and an active order is highlighted in the “Order Book” page, then (following confirmation from the trader) the highlighted order will be referred within the computerised trading system 10. When an order is referred, it is not longer an active order and therefore it will not be matched. A referred order is given the queue number “N/A”. This will cause the “Current Market” page (FIG. 7) to be automatically updated with a new number of orders. It will also automatically update the “Order Book” page. Referring an order has the same effect as removing the order, with regard to trading and matching, but the order details remain in the system so that the trader can re-input the order without having to re-input all of the data.

When the “Refer/Renew” button 24 is clicked on the trading screen in respect of a previously referred order highlighted in the “Order Book Section”, then (following confirmation from the trader) the previously referred order will be made active again within the system. When the order is made active it will be available for matching. When the referred order is made active it will be given a new queue number. The “current market” page of the trading window will automatically be updated with a new number of orders. This will be available to all traders. The queue numbers for any other orders in the same maturity and currency will be updated. Making a referred order active has the same effect as creating a new order with regard to trading and matching but the trader does not have to input order details.

If the “Refer/Renew” button 24 is clicked whilst there is no order highlighted, then a message box will appear asking the trader to select an order. Once an order has been selected then the process described above will take place.

Every trader will be able to access the “Current Market” page of the trading window shown in FIG. 7. This is an area which solely displays information. It shows for a particular trading period the current number of orders which have been placed in the computerised trading system with reference to each currency and each maturity period. In the figure only one currency (Euro) is shown for simplicity but there will be shown on the pages order information by maturity period for each currency traded. An order is either a bid or an offer for sale of a SWAP. The computerised trading system 10 will use stored information to select and highlight in a different colour those order numbers where the trader already has an active order logged in the system.

The computerised system 10 will update the “Current Market” page whenever a new order is entered. The step of viewing the “Current Market” page is shown at step 106 in FIG. 2.

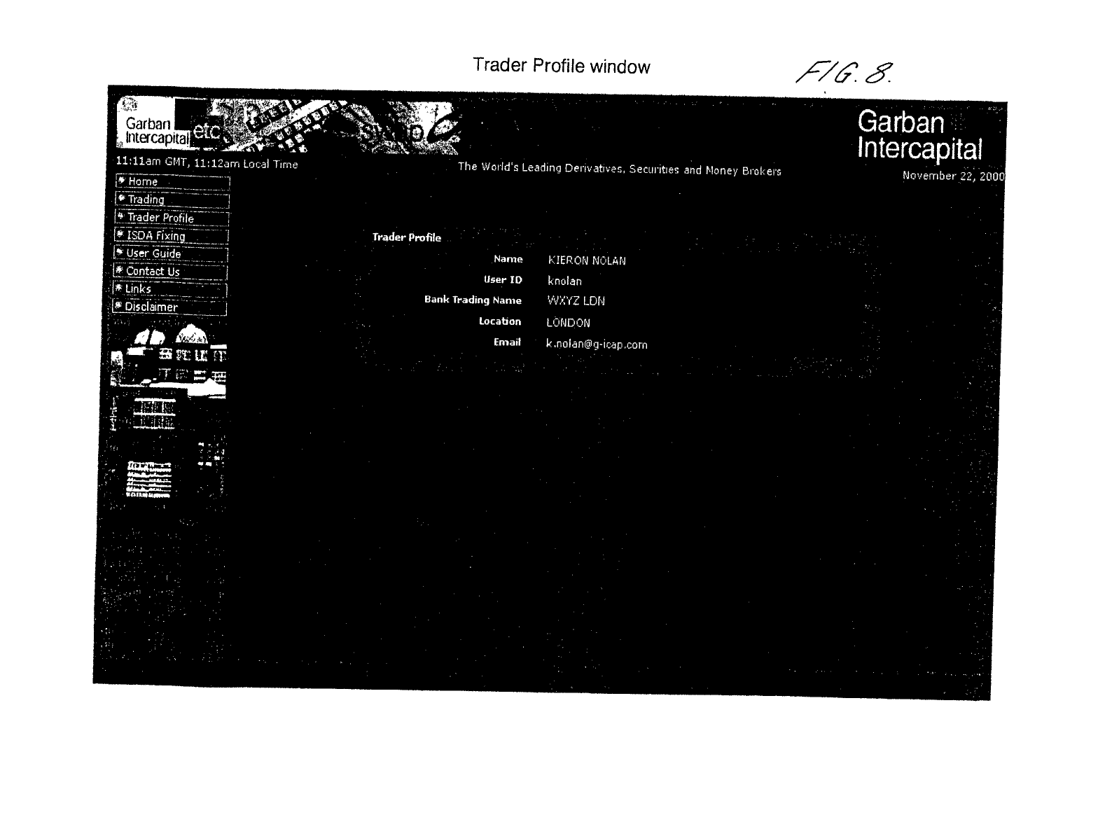

From the Trading Window the trader can also access a trader profile page by clicking a button 36. This page will allow traders to view their own profile, including their contact details. These are the details stored for each trader in the computerised trading system. An example is shown in FIG. 8. The step of viewing the trader profile page is shown at 107 in FIG. 3.

The computerised trading system works such that each day at 11.00 a.m. (or at another specified time) there is a cut off in acceptance of orders and an order entry period is closed. After the end of the order entry period, the traders will not be able to amend active or referred orders, or add orders to the system in respect of the closed order entry period.

Immediately after the end of the order entry period all active orders are logged in the database of the computerised trading system 10 and then matched (where possible) against each other and trades are conditionally generated, subject to the ISDA fix being published (see below). Initially traders are given indicative notices of matched bids and offers and when the price has been fixed then the deals will be notified to the traders responsible for each matched pair of offer and bid automatically by the computerised trading system. This will be described further below.

An algorithm is used to match the trades. The algorithm operates in the following manner for each currency and maturity year combination:

(a) Each order is processed by time priority (i.e. its queue number). The first order submitted to the computerised trading system in the relevant order entry period in each maturity period is tackled first.

(b) A first search is carried out for an exact match of the amount and conditions established by the order, the order being matched successively with other orders with reference to their queue numbers. For instance, if the first order is for Euro 100,000,000 and specifies that a minimum fill amount is Euro 25,000,000 then the first search will determine whether there is a corresponding bid for Euro 100,000,000 with a minimum fill amount of Euro 25,000,000.

(c) If there is no identical match, then the computerised trading system will look for an exact amount match, again searching successively through the orders with reference to their queue numbers. For instance, when the first order is an order to sell £100,000,000 Sterling with a minimum fill size of £25,000,000 Sterling then the computerised trading system will at this stage match the order with a bid to purchase Euro 100,000,000-worth (with no minimum fill size specified).

(d) If the computerised trading system cannot match amounts then the algorithm will match the order sequentially with other orders having regard to the queue numbers of other orders and also having regard to any minimum fill amounts specified. For example, the first order for sale of Euro 100,000,000 with a minimum fill amount of Euro 25,000,000 will be matched e.g. with an order with a next highest queue number for purchase of Euro 75,000,000.

(e) The remaining balance left after the initial matching will become the new first order and this is matched according to the steps mentioned above.

(f) Once the system has tried to match the balance and has either succeeded or failed then the computerised trading system will tackle the next order having regard to the priority of the order indicated by the queue number of the order. In other words the second order submitted in the time period for the relevant maturity period will be processed by the matching system.

When a computerised trading system is able to match an order then a bilateral check will be performed on the credit limit specified by the two financial institutions involved. If the bilateral credit limits specified by the two financial institutions for each other enable the order to be completed then a match will be noted. If a credit limit is not specified for the order by one of the pair of financial institutions in respect of the other then the system will not match the orders.

Once all possible orders are matched then the computerised trading system removes the matched orders from the “Order Book” pages (FIG. 4) viewed by the traders. Also the computerised trading system sends indicative trade e-mails to each relevant trader informing them for each matched order of:

1. the currency of the matched order

2. the maturity of the matched order

3 whether the trader placed the order as payer or receiver

4. the amount of the order

5 a reference to an ISDA fixing (see later).

All matched orders for each trader are published on a “Trading” page individual to that trader. An example is shown as FIG. 9. Each trader can view for each matched order the currency of the order, the maturity period, whether the trader was a payer or receiver for the order, the financial amount and the name of the financial institution with which the trade was made. Initially the right-hand column “Rate” will be empty or filled with zeros.

At this time the computerised trading system server obtains from an independent source a SWAP benchmark rate. This is shown in FIG. 1 by a link of the computerised trading system server 10 to the server 18. It is envisaged that the server 18 will be an independent server, e.g. a server of the Reuters financial information group. The server will publish daily a benchmark rate for SWAPS as determined by the International SWAPS and Derivatives Association (ISDA). The SWAP benchmark rate calculated by ISDA is defined as “the rate provided by the dealer should be the mean of what the dealer would itself offer and bid a SWAP in the relevant maturity for a notional equivalent of US $50,000,000 or whatever amount is the market size in that currency for a tenor to an acknowledged dealer of good credit in the SWAPS market”. The rate is assessed by the ISDA conducting soundings with financial institutions in the market. Currently in respect of United States dollars, the Japanese yen, UK sterling and Euros, the computation takes all the fee rates that have been submitted and eliminates the four highest and the four lowest rates and determines the straight average of the remaining rates, provided that at least 12 rates have been submitted. For Swiss francs the computation takes all the rates that have been submitted, eliminates the two highest and the two lowest rates and determines the straight average of the remaining rates provided that at least six rates have been submitted.

The ISDA also sets standard contract terms for all interest rate SWAPS. The terms are the contract terms which govern all transactions between financial institutions. This allows the computerised trading system of the present invention to act in an unusual manner. Known electronic computerised trading systems usually result with two contracts resulting for each transaction. A first contract is made between the party offering the financial instrument for sale and an intermediary (the intermediary running the electronic trading service) and a second contract is made between the intermediary and the person buying the financial instrument. In most cases, the offeror and the bidder do not ever know the identity of each other. With the trading of SWAPS, because all parties will know the contract terms in advance (these being the standard ISDA contract terms) and because the computerised trading system of the present invention allows each trader to set limits on its trading with other financial institutions, the resulting contracts can be contracts directly between the financial institutions, with the administrator of the computerised trading system simply acting as a facilitator to match one party with another. Furthermore, it should be understood that the match will take place not only on the standard contract terms set by the ISDA but also the match will take place at the daily benchmark rate published by the ISDA with the relevant time period.

The ISDA rate will not be published typically until up to 30 minutes after the end of the order entry period. In that period the traders will know what orders have been matched, but will not know the relevant ISDA rate until it is published. Once the ISDA benchmark rates are fixed then the traders will be notified of completed deals, as can be seen in FIG. 9. E-mails will be sent out to all traders when the fixing has occurred comprising all the information in the initial indicative e-mails, plus the fixed rate.

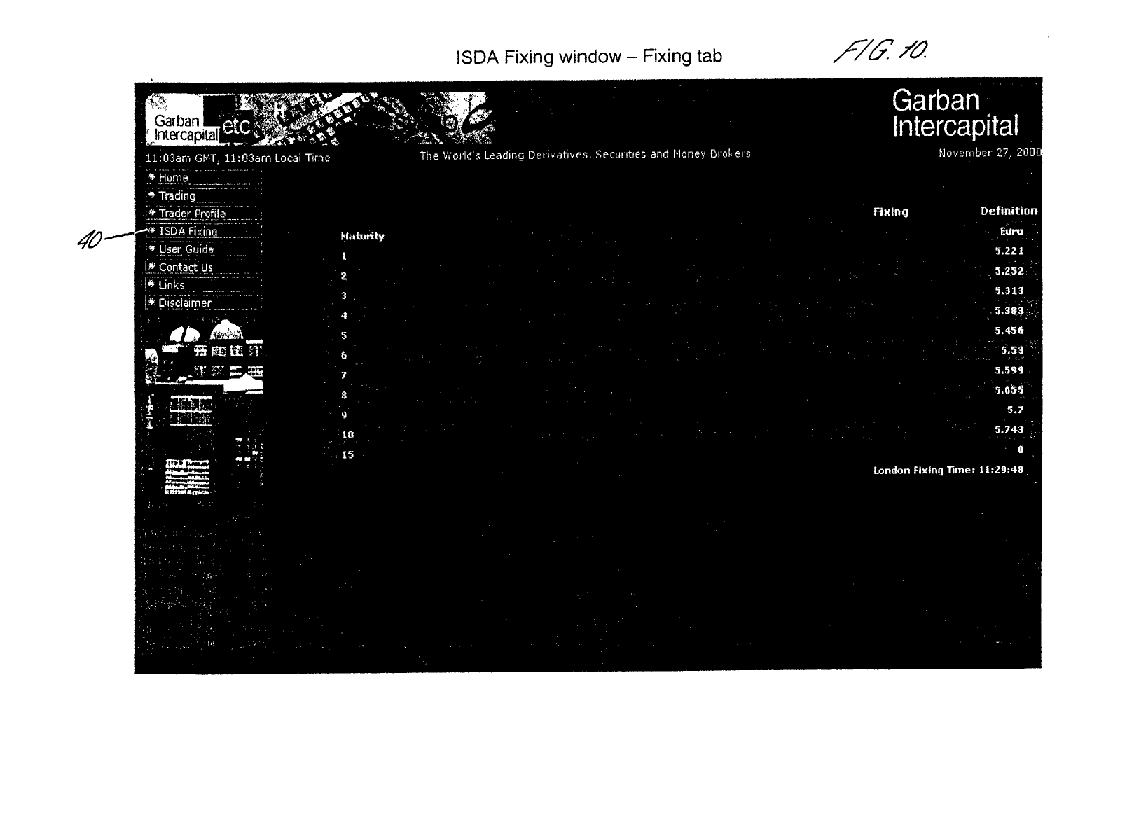

A page showing the ISDA fixing rates is available to all traders and can be seen in FIG. 10. It is accessed by clicking the button 40.

Any unmatched orders remain displayed on the “Order Book” page of the Trading page with the option of being resubmitted for the next day's trading. They will be marked with the status “Rollover”. If there is more than one order from the same trader for the same period and for the same direction (i.e. payer or receiver) then the orders are aggregated, unless the orders happen to be from different traders at the same financial institution, in which case they would remain divided.

All orders that are unmatched and the remainders of any partially matched orders are displayed in the Order Book section of the Trading page. The Order Book fields are populated in the following way:

| | |
|---|---|
| Currency | the currency of the unmatched order |
| Maturity | the maturity of the unmatched order |
| P/R | whether the unmatched order was as a |
| | payer or a receiver |
| Amount | the unmatched amount |
| AON | this indicates whether the unmatched |
| | order was for “all or nothing” |
| Minimum fill | this indicates whether the order had a |
| | minimum fill amount |
| Queue number | this is a blank field |
| Status | rollover. |

At this time, all of the trading buttons described above will be “greyed out” except for the “Agree” button, the “All Out” button and the “Cancel Order” button.

When the “Cancel Order” button is clicked in respect of a previously highlighted order then (following confirmation from the trader) the computerised trading system will remove the highlighted order where its status is noted as “Rollover”. If the button is clicked and no “Rollover” order has been previously highlighted then a message box will appear asking the trader to select a “Rollover” order.

When the “Agree” button is pressed, then all of the orders with a status of “Rollover” will have their status automatically changed to “Active” and will receive queue numbers. These orders will remain in the computerised trading system for the next trading period. They will receive queue numbers at the time that the “Agree” button is clicked. When the “All Out” button is clicked then (following confirmation from the trader) all “Rollover” orders are deleted.

To summarise the above description, there will be daily order entry periods ending at 11.00 a.m. (Or such other time) each day. In each order entry period traders can enter into the computerised trading system orders comprising offers for sale and bids for purchase. These orders will be given a queue number based upon how early in the order entry period the orders are entered. At the end of the order entry period, a matching algorithm described above will try to match up all of the orders. At the end of this process the details of the matched and unmatched orders are made available to all of the traders. Where orders have been matched e-mails will be sent to the traders involved confirming the matching. This matching will involve the forming of a contract between two financial institutions, the terms and conditions of which are governed by the standard ISDA agreement. Initially, e-mails will be sent informing the traders of matched orders, but without relevant rates. Once ISDA rates are fixed then e-mails will be sent confirming fixed rates. Each trader has an individual website page showing him/her the orders placed in an order entry period and also a website page showing him/her trades made following the end of the order entry period. Every trader has access to a website page showing the total numbers of orders placed for each currency in each order entry period.

Once the matches have been made and the ISDA rates published, then the computerised trading system will provide information to a “Back Office” system for settlement of the matched trades. Either printed information can be output for use in an existing “Back Office” system or there will be an electronic link.

Turning now to the role of the system administrator, it has been mentioned above that the system administrator will be able to use a personal computer 17 to access a URL different to the URL of the computerised trading system. The access will be made through a user name and a password page. The system administrator will be able to access a maintenance page, a system administrator benchmark page and a system administrator trading page. The maintenance page will have two sections, a client maintenance section and a general maintenance section. The client maintenance section will be used by the system administrator to add, amend and delete traders registered within the computerised trading system. The general maintenance section will be used to maintain general system parameters such as the minimum amount size for each currency. The maintenance page will be accessible only by the system administrator.

The client maintenance section will list the registered traders on the system and will also have an ADD button, an AMEND button and a DELETE button. By clicking on a listed trader the trader will be highlighted. Subsequent clicking on the AMEND button will bring up a trader's details box populated with the trader's details. If no trader is highlighted at the time that the AMEND button is clicked then a message box will appear asking the system administrator to select a trader. Once the selection is completed then the relevant trader's details box will appear.

The trader's details box itself will contain a CANCEL button, a SAVE button and the following fields:

| | |
|---|---|
| Bank name | This will be an additional |
| User name | identifier for emergency purposes. |
| Password | If a trader has computer equipment |
| Keyword | which fails them he/she can |
| | telephone the system administrator |
| | to cancel all of his/her orders |
| | using his/her user name, password |
| | and keyword to provide |
| | identification |
| E-mail address | this being the currency default |
| Default currency | for the trading page accessed by |
| | the dealer |
| Default maturity | this being a maturity value |
| | default for the relevant field in |
| | the trading page accessed by the |
| | trader |
| Default P/R | this will indicate whether P/R box |
| | in the trading page accessed by |
| | the trader should be defaulted to |
| | P or R |
| Default AON | the default for this field will be |
| | set at NO unless there are some |
| | unusual instructions received |
| Default minimum | this will default to no minimum |
| Fill | fill unless there are some unusual |
| | instructions received |

Any of the above details can be amended by the system administrator and then a SAVE button can be executed to save the amended details.

Clicking on an ADD button will allow the system administrator to open up a new trader's details box with all of the details mentioned above. The system administrator can populate the fields and add a new trader to the system.

When the system administrator clicks on the DELETE button and a registered trader has been previously highlighted then a message box will appear asking for confirmation. If confirmation is given then the registered trader will be deleted from the system along with all orders belonging to that trader. Deletion cannot occur between the publishing of the ISDA benchmark rate and the publishing of the results of the matching process.

If the DELETE button is clicked when no registered trader has been previously highlighted then a message box will appear asking the system administrator to select a registered trader. Once a trader has been selected then a message box will appear asking for confirmation. If confirmation is given then the registered trader will be deleted as described above.

The system administrator will have available a system administrator trading window which will replicate the trading window shown to the traders but will show all orders for all traders. The system administrator will be able to add, delete, cancel and refer/renew any orders in the system The system administrator will also have access to the trader's profile page for all the traders.

Within the maintenance page the administrator will be able to print off details of all trades that have taken place in any trading period.

The computerised trading system will keep a message log file in which all actions by traders will be stored.

It should be appreciated from the above that in any order entry period the traders have anonymity, so that no individual trader knows the identity of the other traders who have placed orders in the trading system although the numbers of orders placed for each currency and maturity will be known publicly and there will be an indication to each trader of the orders placed by that trader (by the highlighting of a relevant combination of currency and maturity). Furthermore, details regarding the size of the orders placed in terms of financial amounts will not be known to any of the traders during any order entry period. The information only becomes available at the end of the matching process and even then the traders will know only the details of their own matched trades and their own unmatched orders.

It is envisaged that the matching process and trade confirmation will take up to 30 minutes between 11.00 a.m. and 11.30 a.m. (or between other specified times) each day, as it takes up to that long for ISDA to publish benchmark rates. No order entry will occur in this period.

Whilst the system has been designed with the trading of interest rate SWAPS in mind, it should be appreciated that the system may also be suitable for other financial instruments and the invention should not be considered as limited to interest rate SWAPS.

It is envisaged that a modification to the system would allow each trader to establish for each other trader total credit limits in each maturity period. The computerised trading system would then automatically reduce the remaining credit available for trading when orders are placed so that each trader does not risk overexposure to a single institution. The computerised trading system would stop placing of orders including that of a financial institution when the remaining credit for the institution is not sufficient.

It is also envisaged that each trader could set limits to the rates at which trades will be made, i.e. a trader could specify that an order is dependent on the ISDA fixing rate being more favourable than a predefined limit.

The computerised trading system uses a method of matching which seeks to minimise the number of parties involved in any matching of a bid or offer. Whilst it is not significant e.g. in a computerised trading system for trading equities for an order for purchase of equities to be filled by the least number of vendors possible, this is important for SWAPS because of the costs of processing agreements between parties.

If at the end of any order entry period the ISDA does not publish benchmark rates then the system administrator can make its own investigations and set rates by itself. At present ISDA contacts 16 financial institutions to obtain 12 rates. If ISDA does not receive 12 replies then the system administrator can discover which institutions have not replied and can contact them directly to obtain the necessary information and then combine this with information previously ascertained by ISDA to calculate rates according to the formula used by ISDA. If information is collected from less than 12 institutions then the system administrator can for each rate take a straight average of rates from the information it receives.

1. A method of use of a computerised trading system to process trades in financial instruments, the computerised trading system comprising:
a trading system computer apparatus;
a plurality of client computer apparatus located physically remote from each other and physically remote from the trading system computer apparatus; and
a telecommunications network interlinking the trading system computer apparatus and the plurality of client computer apparatus;
wherein:
the method comprises the steps of:
(a) a first plurality of traders using the client computer apparatus to send to the trading system computer apparatus via the telecommunications network a plurality of offers for sale of financial instruments;
(b) a second plurality of traders using the client computer apparatus to send to the trading system computer apparatus via the telecommunications network a plurality of bids for purchase of financial instruments; and
(c) a trading administrator using the trading system computer apparatus to:
establish a succession of time limited order entry periods during which offers for sale and bids for purchase can be submitted to the trading system computer apparatus;
compare all offers for sale and bids for purchase made in a single order entry period at the end of the order entry period;
to match where possible the compared offers for sale and bids for purchase;
to record for each order entry period at least one benchmark trading rate; and
to make available electronically via the telecommunications network to all relevant traders information regarding the offers and/or bids which have been matched, such information for each matched pair of offer and bid being sent only to the traders who made the matched offer and bid and such information including the identity of the traders responsible for each matched pair of offer and bid and the benchmark trading rate set for the transaction.

2. A method as claimed in claim 1 wherein each offer and each bid specifies a financial value and the trading system computer apparatus when matching offers and bids initially attempts for each offer to find a bid which is of exactly the same financial value and initially attempts for each bid to find an offer which is of exactly the same financial value.

3. A method as claimed in claim 1 wherein:
the trading system computer apparatus allocates to each offer and each bid a queue number allocating a priority to the offer or bid dependent on how soon after the start of an order entry period the offer or bid is made; and
the trading system computer apparatus at the end of each order entry period compares bids and offers made in the order entry period by starting with the bid or offer with the earliest queue number and then comparing the bid or offer with later made bids or offers successively having reference to the queue numbers of the later made bids or offers and starting with the earliest later made bid or offer.

4. A method as claimed in claim 2 wherein:
the trading system computer apparatus allocates to each offer and each bid a queue number allocating a priority to the offer or bid dependent on how soon after the start of an order entry period the offer or bid is made; and
the trading system computer apparatus at the end of each order entry period compares bids and offers made in the order entry period by starting with the bid or offer with the earliest queue number and then comparing the bid or offer with later made bids or offers successively having reference to the queue numbers of the later made bids or offers and starting with the earliest later made bid or offer.

5. A method as claimed in claim 1, wherein:
each offer for sale contains information regarding a financial value of each financial instrument and a maturity date of each financial instrument;
each bid for purchase contains information regarding a financial value of each financial instrument requested and a maturity date of each financial instrument; and
the computerised trading system matches bids and offers by matching the financial values and maturity dates of the bids and offers.

6. A method as claimed in claim 2, wherein:
each offer for sale contains information regarding a financial value of each financial instrument and a maturity date of each financial instrument;
each bid for purchase contains information regarding a financial value of each financial instrument requested and a maturity date of each financial instrument; and
the computerised trading system matches bids and offers by matching the financial values and maturity dates of the bids and offers.

7. A method as claimed in claim 3, wherein:
each offer for sale contains information regarding a financial value of each financial instrument and a maturity date of each financial instrument;
each bid for purchase contains information regarding a financial value of each financial instrument requested and a maturity date of each financial instrument; and
the computerised trading system matches bids and offers by matching the financial values and maturity dates of the bids and offers.

8. A method as claimed in claim 4, wherein:
each offer for sale contains information regarding a financial value of each financial instrument and a maturity date of each financial instrument;
each bid for purchase contains information regarding a financial value of each financial instrument requested and a maturity date of each financial instrument; and
the computerised trading system matches bids and offers by matching the financial values and maturity dates of the bids and offers.

9. A method as claimed in claim 5 wherein:
each offer for sale contains information specifying whether the offer must be accepted in full or whether the offer can be accepted in part;
the computerised trading system checks initially whether each offer for sale can be matched in full with a bid for purchase and when an offer for sale which can be accepted in part cannot be matched in full then the computerised trading system will match the offer for sale with a bid for purchase of a lesser financial value and will calculate a remainder value; and
the computerised trading system attempts to match the remainder value of each offer for sale with remaining bids for purchase.

10. A method as claimed in claim 6 wherein:
each offer for sale contains information specifying whether the offer must be accepted in full or whether the offer can be accepted in part;
the computerised trading system checks initially whether each offer for sale can be matched in full with a bid for purchase and when an offer for sale which can be accepted in part cannot be matched in full then the computerised trading system will match the offer for sale with a bid for purchase of a lesser financial value and will calculate a remainder value; and
the computerised trading system attempts to match the remainder value of each offer for sale with remaining bids for purchase.

11. A method as claimed in claim 7 wherein:
each offer for sale contains information specifying whether the offer must be accepted in full or whether the offer can be accepted in part;
the computerised trading system checks initially whether each offer for sale can be matched in full with a bid for purchase and when an offer for sale which can be accepted in part cannot be matched in full then the computerised trading system will match the offer for sale with a bid for purchase of a lesser financial value and will calculate a remainder value; and
the computerised trading system attempts to match the remainder value of each offer for sale with remaining bids for purchase.

12. A method as claimed in claim 8 wherein:
each offer for sale contains information specifying whether the offer must be accepted in full or whether the offer can be accepted in part;
the computerised trading system checks initially whether each offer for sale can be matched in full with a bid for purchase and when an offer for sale which can be accepted in part cannot be matched in full then the computerised trading system will match the offer for sale with a bid for purchase of a lesser financial value and will calculate a remainder value; and
the computerised trading system attempts to match the remainder value of each offer for sale with remaining bids for purchase.

13. A method as claimed in claim 5 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

14. A method as claimed in claim 6 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

15. A method as claimed in claim 7 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

16. A method as claimed in claim 8 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

17. A method as claimed in claim 9 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

18. A method as claimed in claim 10 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

19. A method as claimed in claim 11 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

20. A method as claimed in claim 12 wherein:
each bid for purchase contains information specifying whether the bid must be accepted in full or whether the bid can be accepted in part;
the computerised trading system checks initially whether each bid for purchase can be matched in full with an offer for sale and when a bid for purchase which can be accepted in part cannot be matched in full then the computerised trading system will match the bid for purchase with an offer for sale of a lesser financial value and will calculate a remainder value; and
the computerised trading system attempts to match the remainder value of each bid for purchase with remaining offers for sale.

21. A method as claimed in claim 1 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

22. A method as claimed in claim 2 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

23. A method as claimed in claim 3 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

24. A method as claimed in claim 4 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

25. A method as claimed in claim 5 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

26. A method as claimed in claim 6 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

27. A method as claimed in claim 7 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

28. A method as claimed in claim 8 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

29. A method as claimed in claim 9 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

30. A method as claimed in claim 10 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

31. A method as claimed in claim 11 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

32. A method as claimed in claim 12 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

33. A method as claimed in claim 13 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

34. A method as claimed in claim 14 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

35. A method as claimed in claim 15 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

36. A method as claimed in claim 16 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

37. A method as claimed in claim 17 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

38. A method as claimed in claim 18 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

39. A method as claimed in claim 19 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

40. A method as claimed in claim 20 wherein each trader when making an offer or a bid specifies which other traders can be considered for a matching bid or offer and the trading computer apparatus considers the identities of the traders responsible for each potential pair of matched bid and offer and will match the pair of bid and offer only if each relevant trader has been specified as an acceptable trader by the other.

41. A method as claimed in claim 1 wherein the financial instruments traded each have a maturity date and the trading system computer apparatus makes accessible to all the traders via the telecommunications network a record of how many bids and offers have been made in total by all traders for financial instruments in a plurality of maturity periods.

42. A method as claimed in claim 2 wherein the financial instruments traded each have a maturity date and the trading system computer apparatus makes accessible to all the traders via the telecommunications network a record of how many bids and offers have been made in total by all traders for financial instruments in a plurality of maturity periods.

43. A method as claimed in claim 3 wherein the financial instruments traded each have a maturity date and the trading system computer apparatus makes accessible to all the traders via the telecommunications network a record of how many bids and offers have been made in total by all traders for financial instruments in a plurality of maturity periods.

44. A method as claimed in claim 4 wherein the financial instruments traded each have a maturity date and the trading system computer apparatus makes accessible to all the traders via the telecommunications network a record of how many bids and offers have been made in total by all traders for financial instruments in a plurality of maturity periods.

45. A method as claimed in claim 5 wherein the financial instruments traded each have a maturity date and the trading system computer apparatus makes accessible to all the traders via the telecommunications network a record of how many bids and offers have been made in total by all traders for financial instruments in a plurality of maturity periods.

46. A method as claimed in claim 6 wherein the financial instruments traded each have a maturity date and the trading system computer apparatus makes accessible to all the traders via the telecommunications network a record of how many bids and offers have been made in total by all traders for financial instruments in a plurality of maturity periods.

47. A method as claimed in claim 7 wherein the financial instruments traded each have a maturity date and the trading system computer apparatus makes accessible to all the traders via the telecommunications network a record of how many bids and offers have been made in total by all traders for financial instruments in a plurality of maturity periods.

48. A method as claimed in claim 8 wherein the financial instruments traded each have a maturity date and the trading system computer apparatus makes accessible to all the traders via the telecommunications network a record of how many bids and offers have been made in total by all traders for financial instruments in a plurality of maturity periods.

49. A method as claimed in claim 9 wherein the financial instruments traded each have a maturity date and the trading system computer apparatus makes accessible to all the traders via the telecommunications network a record of how many bids and offers have been made in total by all traders for financial instruments in a plurality of maturity periods.

50. A method as claimed in claim 10 wherein the financial instruments traded each have a maturity date and the trading system computer apparatus makes accessible to all the traders via the telecommunications network a record of how many bids and offers have been made in total by all traders for financial instruments in a plurality of maturity periods.

51. A method as claimed in claim 11 wherein the financial instruments traded each have a maturity date and the trading system computer apparatus makes accessible to all the traders via the telecommunications network a record of how many bids and offers have been made in total by all traders for financial instruments in a plurality of maturity periods.

52. A method as claimed in claim 12 wherein the financial instruments traded each have a maturity date and the trading system computer apparatus makes accessible to all the traders via the telecommunications network a record of how many bids and offers have been made in total by all traders for financial instruments in a plurality of maturity periods.

53. A method as claimed in claim 13 wherein the financial instruments traded each have a maturity date and the trading system computer apparatus makes accessible to all the traders via the telecommunications network a record of how many bids and offers have been made in total by all traders for financial instruments in a plurality of maturity periods.

54. A method as claimed in claim 14 wherein the financial instruments traded each have a maturity date and the trading system computer apparatus makes accessible to all the traders via the telecommunications network a record of how many bids and offers have been made in total by all traders for financial instruments in a plurality of maturity periods.

55. A method as claimed in claim 15 wherein the financial instruments traded each have a maturity date and the trading system computer apparatus makes accessible to all the traders via the telecommunications network a record of how many bids and offers have been made in total by all traders for financial instruments in a plurality of maturity periods.

56. A method as claimed in claim 16 wherein the financial instruments traded each have a maturity date and the trading system computer apparatus makes accessible to all the traders via the telecommunications network a record of how many bids and offers have been made in total by all traders for financial instruments in a plurality of maturity periods.

57. A method as claimed in claim 17 wherein the financial instruments traded each have a maturity date and the trading system computer apparatus makes accessible to all the traders via the telecommunications network a record of how many bids and offers have been made in total by all traders for financial instruments in a plurality of maturity periods.

58. A method as claimed in claim 18 wherein the financial instruments traded each have a maturity date and the trading system computer apparatus makes accessible to all the traders via the telecommunications network a record of how many bids and offers have been made in total by all traders for financial instruments in a plurality of maturity periods.

59. A method as claimed in claim 19 wherein the financial instruments traded each have a maturity date and the trading system computer apparatus makes accessible to all the traders via the telecommunications network a record of how many bids and offers have been made in total by all traders for financial instruments in a plurality of maturity periods.

60. A method as claimed in claim 20 wherein the financial instruments traded each have a maturity date and the trading system computer apparatus makes accessible to all the traders via the telecommunications network a record of how many bids and offers have been made in total by all traders for financial instruments in a plurality of maturity periods.

61. Use of a personal computer as client computer apparatus in a computerised trading system operated to process trades in financial instruments according to a method as claimed in claim 1.

62. Use of a personal computer as client computer apparatus in a computerised trading system operated to process trades in financial instruments according to a method as claimed in claim 2.

63. Use of a personal computer as client computer apparatus in a computerised trading system operated to process trades in financial instruments according to a method as claimed in claim 3.

64. Use of a personal computer as client computer apparatus in a computerised trading system operated to process trades in financial instruments according to a method as claimed in claim 4.

65. Use of a personal computer as client computer apparatus in a computerised trading system operated to process trades in financial instruments according to a method as claimed in claim 5.

66. Use of a personal computer as client computer apparatus in a computerised trading system operated to process trades in financial instruments according to a method as claimed in claim 6.

67. Use of a personal computer as client computer apparatus in a computerised trading system operated to process trades in financial instruments according to a method as claimed in claim 7.

68. Use of a personal computer as client computer apparatus in a computerised trading system operated to process trades in financial instruments according to a method as claimed in claim 8.

69. Use of a personal computer as client computer apparatus in a computerised trading system operated to process trades in financial instruments according to a method as claimed in claim 9.

70. Use of a personal computer as client computer apparatus in a computerised trading system operated to process trades in financial instruments according to a method as claimed in claim 10.

71. Use of a personal computer as client computer apparatus in a computerised trading system operated to process trades in financial instruments according to a method as claimed in claim 11.

72. Use of a personal computer as client computer apparatus in a computerised trading system operated to process trades in financial instruments according to a method as claimed in claim 12.

73. Use of a personal computer as client computer apparatus in a computerised trading system operated to process trades in financial instruments according to a method as claimed in claim 13.

74. Use of a personal computer as client computer apparatus in a computerised trading system operated to process trades in financial instruments according to a method as claimed in claim 14.

75. Use of a personal computer as client computer apparatus in a computerised trading system operated to process trades in financial instruments according to a method as claimed in claim 15.

76. Use of a personal computer as client computer apparatus in a computerised trading system operated to process trades in financial instruments according to a method as claimed in claim 16.

77. Use of a personal computer as client computer apparatus in a computerised trading system operated to process trades in financial instruments according to a method as claimed in claim 17.

78. Use of a personal computer as client computer apparatus in a computerised trading system operated to process trades in financial instruments according to a method as claimed in claim 18.

79. Use of a personal computer as client computer apparatus in a computerised trading system operated to process trades in financial instruments according to a method as claimed in claim 19.

80. Use of a personal computer as client computer apparatus in a computerised trading system operated to process trades in financial instruments according to a method as claimed in claim 20.

81. Use of one or more computer servers as a trading computer apparatus in a computerised trading system operated to process trades in financial instruments according to a method as claim 1.

82. Use of one or more computer servers as a trading computer apparatus in a computerised trading system operated to process trades in financial instruments according to a method as claimed in claim 2.

83. Use of one or more computer servers as a trading computer apparatus in a computerised trading system operated to process trades in financial instruments according to a method as claimed in claim 3.

84. Use of one or more computer servers as a trading computer apparatus in a computerised trading system operated to process trades in financial instruments according to a method as claimed in claim 4.

85. Use of one or more computer servers as a trading computer apparatus in a computerised trading system operated to process trades in financial instruments according to a method as claimed in claim 5.

86. Use of one or more computer servers as a trading computer apparatus in a computerised trading system operated to process trades in financial instruments according to a method as claimed in claim 6.

87. Use of one or more computer servers as a trading computer apparatus in a computerised trading system operated to process trades in financial instruments according to a method as claimed in claim 7.

88. Use of one or more computer servers as a trading computer apparatus in a computerised trading system operated to process trades in financial instruments according to a method as claimed in claim 8.

89. Use of one or more computer servers as a trading computer apparatus in a computerised trading system operated to process trades in financial instruments according to a method as claimed in claim 9.

90. Use of one or more computer servers as a trading computer apparatus in a computerised trading system operated to process trades in financial instruments according to a method as claimed in claim 10.

91. Use of one or more computer servers as a trading computer apparatus in a computerised trading system operated to process trades in financial instruments according to a method as claimed in claim 11.

92. Use of one or more computer servers as a trading computer apparatus in a computerised trading system operated to process trades in financial instruments according to a method as claimed in claim 12.

93. Use of one or more computer servers as a trading computer apparatus in a computerised trading system operated to process trades in financial instruments according to a method as claimed in claim 13.

94. Use of one or more computer servers as a trading computer apparatus in a computerised trading system operated to process trades in financial instruments according to a method as claimed in claim 14.

95. Use of one or more computer servers as a trading computer apparatus in a computerised trading system operated to process trades in financial instruments according to a method as claimed in claim 15.

96. Use of one or more computer servers as a trading computer apparatus in a computerised trading system operated to process trades in financial instruments according to a method as claimed in claim 16.

97. Use of one or more computer servers as a trading computer apparatus in a computerised trading system operated to process trades in financial instruments according to a method as claimed in claim 17.

98. Use of one or more computer servers as a trading computer apparatus in a computerised trading system operated to process trades in financial instruments according to a method as claimed in claim 18.

99. Use of one or more computer servers as a trading computer apparatus in a computerised trading system operated to process trades in financial instruments according to a method as claimed in claim 19.

100. Use of one or more computer servers as a trading computer apparatus in a computerised trading system operated to process trades in financial instruments according to a method as claimed in claim 20.
